(19) United States
(12) Patent Application Publication
(10) Pub. No.: US 2005/0031116 A1
(43) Pub. Date: Feb. 10, 2005

(54) Method for activating an indicating element, terminal device and program

(76) Inventors: Thomas Lederer, Munchen (DE); Georg Schwojer, Pflauendorf (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/891,767

(22) Filed: Jul. 15, 2004

(30) Foreign Application Priority Data
Aug. 4, 2003 (DE) 10335619.3

(51) Int. Cl. H04M 1/00; H04M 3/00

(52) U.S. Cl. 379/355.01

(57) ABSTRACT

Among other matters, a method is disclosed whereby an indicating element on a telephone (120) is activated as a function of an item of reachability data. This reachability data is generated by a different piece of equipment than the reachable terminal device, or on the reachable terminal device without simultaneously establishing or releasing a connection, e.g. by pressing a reachability key (150). The method permits improved activation of indicating elements, and substantially reduces the number of connection requests made in vain.

### CROSS REFERENCE TO RELATED APPLICATIONS

This application claims priority to the German application No. 10335619.3, filed Aug. 4, 2003 and which is incorporated by reference herein in its entirety.

### FIELD OF INVENTION

The invention concerns a method for activating an indicating element on a terminal device in a data transmission network or a telecommunication network.

### BACKGROUND OF INVENTION

In contrast to operating buttons which are merely displayed on a screen, the use of keys which are physically present also makes it possible to use the keys in a simple manner. In particular, there is no need for an additional surface on which to lay a so-called computer mouse. In addition, it is only necessary to realize in the terminal device those units which are absolutely essential for the establishment of a connection, for the transmission of the useful data and for releasing the connection.

DE 101 49 983 A1 discloses a method for activating an indicating element which can be used in a network of telecommunication installations to “call in” a call. For example, an indicating element flashes when a terminal device, which can be reached via a key which is assigned to the indicating element, is called. If the indicating element flashes for a longer time, there is the option to divert the incoming call to the terminal device on which the indicating element is flashing, because it can be assumed that the original call request has failed to reach the subscriber who was being called. This method is carried out, for example, in installations of the HICOM type from Siemens AG. However, it is also possible to use telecommunication installations from other companies, or even control units in a data transmission network.

The indicating elements and the quick-dial keys are heavily used by many subscribers, and thus have a high level of acceptance.

### SUMMARY OF INVENTION

It is the object of the invention to specify an improved method for activating an indicating element, the use of which will, in particular, reduce the number of call requests which are generated in vain or which disturb the called subscriber, as applicable. In addition, it is to specify a terminal device and a program.

Below, the terminal device is also referred to as a reference terminal device. The terminal device is equipped with several keys, each of which can be used to establish a connection to another terminal device. These keys are also called quick-dialing keys because, instead of needing to input a sequence of digits by means of several keys, it is only necessary to press one key in order to request a connection to the terminal device concerned. Each key incorporates an electronic or mechanical switching element which switches when the key is pressed. In addition, the reference terminal device contains several indicating elements, each of which is assigned to one key. The operational state of the indicating element depends on inputs from the particular user who uses the terminal device which can be reached via the key.

The invention starts from the consideration that the activation of an indicating element solely on the basis of the switching state of a terminal device can cause operating errors. Thus, for example, the incoming call can be diverted by another subscriber, before the called subscriber reaches his/her terminal device.

For this reason, with the method in accordance with the invention, the indicating element or a part of it is controlled on the basis of reachability data. For its part, the reachability data is generated in a piece of equipment other than the reachable device, as a function of inputs made by the user. Alternatively, the reachability data may be input at the reachable terminal device without a simultaneous connection set-up or release in the data transmission network or in the telecommunication network. In particular, the reachability data remains the same for the duration of several connections. This measure achieves a situation in which it is possible to indicate to the user of a terminal device, even before a connection request is generated, reliable information about the reachability of the terminal device which is to be called. In addition, in order to realize the method in accordance with the invention, the familiar methods only need to be slightly modified, for example by software updates. The basic form of the method in accordance with the invention does not even require changes to the terminal devices.

A development uses as the reference device or the reachable terminal device a telephone which is connected to a telecommunication installation or which, in its form of housing and the arrangement of the operating elements, is equivalent to a terminal device connected to a telecommunication installation, but which works within a data transmission network. The reference terminal device or the reachable terminal device, as applicable, is thus a device which is optimized for the application of “telephoning”, distinguished by being easy to operate. For example, the telephone may contain a real time operating system, with no mass storage for several gigabytes, such as a hard disk, no CD-ROM drive and/or no connection for a computer mouse.

In a further development, the switching element is at least one metallic contact, for example in a key. Alternatively, a transistor is used as the switching element, for example a bipolar transistor or a transistor with an insulated gate. This transistor is activated, for example without components subject to mechanical wear, by a capacitive, resistive, or piezo-sensor, which detects the touching of a key by a finger.

In another development, the electronic equipment is a piece of equipment, other than the reachable terminal device, which is used by the user of the reachable terminal device, in particular a data processing system such as a personal computer, a time recording system or a portable computer. The data processing system has an access to a data transmission network, so that the reachability data can be used by the method according to the invention.

In another development, a central place stores a list in which the terminal device is noted, and to which any change in a particular item of reachability data should be signaled. The change to any item of reachability data is then signaled to the terminal devices concerned, depending on the state of the list. Holding and administering the list at a central place has numerous associated advantages, for example in terms of a set of data which has no internal contradictions.

In another development, the reachability data is noted in the list and the list created in accordance with the CSTA standard (Computer Supported Telecommunications Application), which has been published by the ECMA (European Computer Manufacturer Association). Alternatively, the reachability data is provided using messages in accordance with the SIP standards (Session Initiation Protocol), which have been drawn up by the IETF (Internet Engineering Task Force). Another possibility is the use of the H.323 standard published by the ITU-T (International Telecommunication Union—Telecommunications Standardization Sector), or a standard based on this standard. The standards cited are in widespread use, so that many pieces of equipment which already exist can process the messages.

In another development, a central service provision computer stores the list. This central service provision computer can be operated either outside any telecommunication installation or also as a component of a telecommunication installation.

With an alternative development, the reachable terminal device stores a list in which are specified the terminal devices which must be informed if there is any change in the reachability data, in particular the reference terminal device. The terminal device signals to the terminal devices concerned the change in the reachability data, depending on the state of the list. In the list are noted, for example, the directory numbers or other identifiers of the terminal devices which must be informed of the change in the reachability data. The local storage of lists, each in one terminal device, enables the method to be performed without a central instance. Even if the lists are stored locally, it is still possible to use the standards cited above for the purpose of signaling a change in the reachability data.

In another development, the following reachability states are noted in the reachability data:
user is logged into a user program or operating system, for example the program recognizes the login automatically on the basis of a user input,
user logged off from a user program or operating system,
user occupied,
user will be back soon,
user not there,
user away over lunch,
user on the telephone.

The signaling of these various reachability states makes it possible to determine simply and with confidence the time when a connection can be successfully established.

In accordance with another aspect of the invention, a terminal device is specified which is, in particular, suitable for carrying out the method in accordance with the invention, or one of its developments. The terminal device contains indicating elements and keys, in particular quick-dial keys. In addition, the terminal device contains a telephone handset, or at least a connector for a telephone handset. The terminal device includes in addition a housing, and can be operated on a telecommunication installation, or has a housing shaped like that of a telephone which can be operated on a telecommunication installation. The terminal device has in addition a key for inputting reachability data without at the same time establishing or releasing a connection. The reachability data is input via a key provided for that purpose, a key combination or via a menu which can be operated with the help of the key. With this, the user of the telephone can in a simple way input into the terminal device the value of an item of reachability data.

With a development, the terminal device is given several indicating elements, each of which is arranged beside a key which can in each case be used to reach another terminal device. For example, the indicating element might be located in the key or beside the key. LCD (Liquid Crystal Display) indicators or LEDs (Light Emitting Diode) are particularly suitable for use as indicating elements. So there are, for example, multicolor LEDs which, depending on how they are activated, are illuminated in red, blue or green. An LCD element has the advantage that it is possible, with the help of symbols, to represent numerous reachability states in a very easily-remembered and comprehensible manner.

With an alternative development, an indicating element is provided, preferably an LCD element, which contains indicating element segments, each arranged beside a key which can be used to reach other terminal devices. For example, a key is arranged beside each line of the LCD element. This arrangement simplifies the construction of the terminal device.

A further aspect of the invention relates to a program which, when it is executed by a processor, carries out the method in accordance with the invention or one of its developments. Consequently, the above technical effects also apply for the program.

### BRIEF DESCRIPTION OF THE DRAWINGS

Below, exemplary embodiments of the invention are explained by reference to the attached drawings. These show:

FIG. 1 an exemplary embodiment with central storage of lists for signaling reachability data,

FIG. 2 an exemplary embodiment with local storage of lists for signaling reachability data,

FIG. 3 operational states of an indicating element, depending on the value of an item of reachability data, and

FIG. 4 a terminal device with a key for the input of an item of reachability data.

### DETAILED DESCRIPTION OF INVENTION

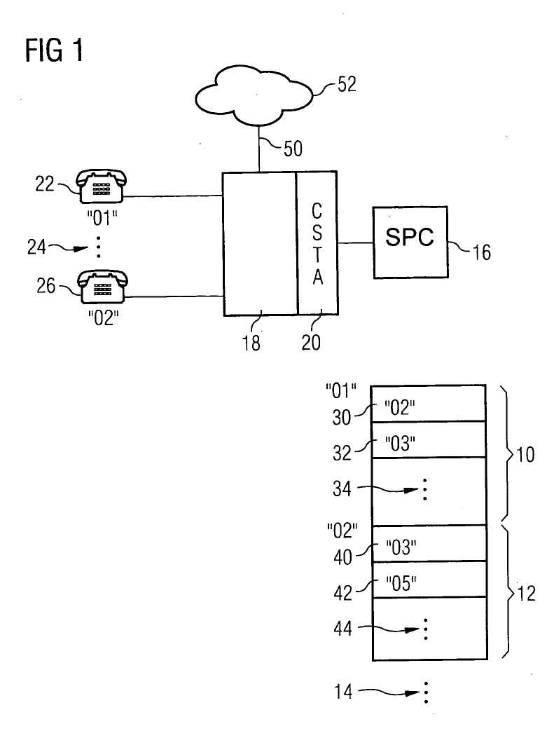

FIG. 1 shows an exemplary embodiment with central storage of lists, 10, 12 und 14, in a central service provision computer 16. The service provision computer 16 communicates with a telecommunication installation 18, for example via a CSTA interface 20. The telecommunication installation 18 is connected to a public telephone network 52 via a PCM (Pulse Code Modulation) line 50. In the case of another exemplary embodiment, there is one central service provision computer 16 for several telecommunication installations 18, i.e. for a network of telecommunication installations 18.

The telecommunication installation 18 is, for example, a system of the HICOM type or of the HiPath type, from Siemens AG. Connected to the telecommunication installation 18 is a host of telephones or terminal devices, as applicable, 22, 24 and 26. For example, the telephones 22 to 26 might be telephones of the Optiset type from Siemens AG. In the exemplary embodiment, the identifier “01” or its directory number, as applicable, is assigned to the telephone 22. The identifier “02” is assigned to the telephone 26. Corresponding to the usage of the quick-dial keys on telephone 22, it is noted in the first data field 30 of the list 10 that there is a first quick-dial key for telephone 22 with the identifier “02”. In a second data field 32 in the list 10 it is noted for telephone 22 that there is a second quick-dial key for a telephone with the identifier “03”. In further data fields 34 in the list 10 are noted further quick-dial destinations which can be reached from telephone 22.

In a first data field 40 in the list 12, a note is made for telephone 26 that the telephone with the identifier “03” can be reached by means of a first quick-dial key. In a second data field 42 in the list 12 it is noted that a telephone with the identifier “05” can be reached by means of a second quick-dial key. Further data fields 44 in the list 12 note the telephones to which the remaining quick-dial keys of telephone 26 lead.

The lists 10 and 12, together with the remaining lists 14, can be created, i.e. in particular also can be changed, either from within the terminal devices 22 to 26 or centrally.

As explained in more detail below by reference to FIG. 4, each of the telephones 22 to 26 has a key, by means of which the subscriber who uses each of the telephones 22 to 26 can input their reachability. If, for example, the availability data for this telephone 22 is changed from telephone 22, then from the list 10 it will be determined that the change in the operational state of telephone 22 must be indicated to telephone 26, which has the identifier “02”, and to the telephone with the identifier “03”. The change in the indication will be signaled out, for example using CSTA messages, to the telephone 26 or the telephone with the identifier “03” respectively. In the case of the exemplary embodiment explained by reference to FIG. 1, the reachability data will not be stored away in the lists 10 to 14. On the other hand, for another exemplary embodiment the reachability data will be stored away at least once in the lists 10 to 14. For example, the reachability data for telephone 22 can be saved in a data field header in the list 10. Alternatively, or additionally, the reachability data can also be saved into other lists 12 or 14 if these lists include the identifier “01” for the terminal device 22.

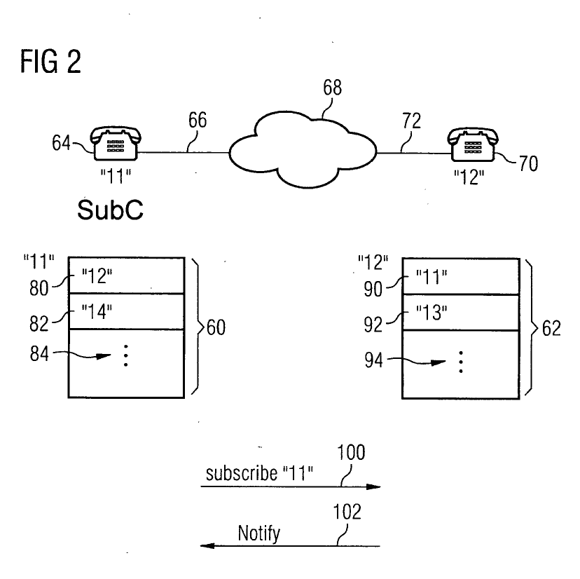

FIG. 2 shows an exemplary embodiment with local storage of the lists, 60 and 62, which are used for signaling changes to an item of reachability data. The list 60 is stored in a terminal device 64 which, for example, works in accordance with the SIP (Session Initiation Protocol). The terminal device 64 is linked via a line 66 to a data transmission network 68, for example to a LAN (Local Area Network) or to the Internet. The terminal device 64 is assigned an identifier “11”, for example its address in the data transmission network 68.

A terminal device 70 is connected to the data transmission network 68 via a line 72. The terminal device 70 also works in accordance with the SIP. An identifier “12” is assigned to the terminal device 70.

The list 60 stored in the terminal device 64 contains, in a first data field 80, the identifier “12” of the terminal device 70. In a second data field 82 in the list 60 is stored the identifier “14” for a further terminal device—which is not shown. In further data fields 84 are stored further identifiers for terminal devices—not shown—which can be reached from the terminal device 64 via quick-dial keys.

In a first data field 90 in the list 62 is stored the identifier “11” of the terminal device 64. In a second data field 92 in the list 62 is stored the identifier “13” of another terminal device. In further data fields 94 in the list 62 are stored the identifiers of further terminal devices which can be reached using the terminal device 70 via quick-dial keys. As a result, the terminal devices 64 and 70 are suitable for the service of “telephoning”. In the case of another exemplary embodiment, the terminal devices 64 and 70 are also used as video-phones or as terminal devices in a “conference circuit” with more than two terminal devices.

After a subscriber SubC has assigned to a quick-dial key on the terminal device 64 the identifier “12” of the terminal device 70, an entry message 100 is automatically generated in the terminal device 64 and is sent to the terminal device 72. This entry message 100 transmits the identifier “11”. This identifier “11” is then saved in data field 90. After it receives the entry message 100, the terminal device 72 may optionally generate a confirmation message 102, and send it to the terminal device 64, to signal its receipt and the orderly amendment of the list 62. The entry message 100 and the confirmation message 102 are transmitted in accordance with the SIP.

The terminal devices 64 and 70 also contain keys for the input of a reachability status without this being part of a call processing sequence. For example, if the value of the reachability data for the terminal device 64 changes, then the list 60 is used to determine the terminal devices to which the change should be signaled. The amended value of the reachability data is transmitted to the terminal device or terminal devices concerned, as applicable, in a change message. According to the first data field 80 in the list 60, the change must be signaled to the terminal device with the identifier “12”, i.e. to terminal device 70. After this signaling has been carried out, the data fields 82 to 84 which follow in the list 60 are processed.

If the terminal device 70 receives an SIP message about a change to an operational state, then by referring to the message-sender it can determine which indicating element is to be activated in accordance with the change. In the exemplary embodiment, the sender contained in the SIP message is the identifier “11”, so that activation must be reset for the indicating element beside the key for quick-dialing to the terminal device 64, which has the identifier “11”.

In the case of other exemplary embodiments, terminal devices which work in accordance with protocols which differ from each other are involved in method which has been explained, i.e. in the case of the method explained by reference to FIG. 1, for example, terminal devices which work in accordance with the SIP protocol are also involved, or in the case of the method explained by reference to FIG. 2 telephones 22 to 26 which are connected to a telecommunication installation are also involved. In addition, mobile or cellular communication terminal devices, computers, PDAs (Personal Digital Assistant) and notebooks, which can be reached via data transmission networks or via a mobile telephony network, as applicable, can also be involved.

In the case of other exemplary embodiments, as an addition to or replacement for the possibility of inputting the reachability data using a special key, the reachability data is amended automatically, for example depending on:
the state of a time recording system, which records the working hours for a subscriber, e.g. for subscriber SubC, who logs onto or off from the time recording system using a smart card;
a subscriber's logging onto or off from a computer located beside his/her terminal device, etc.

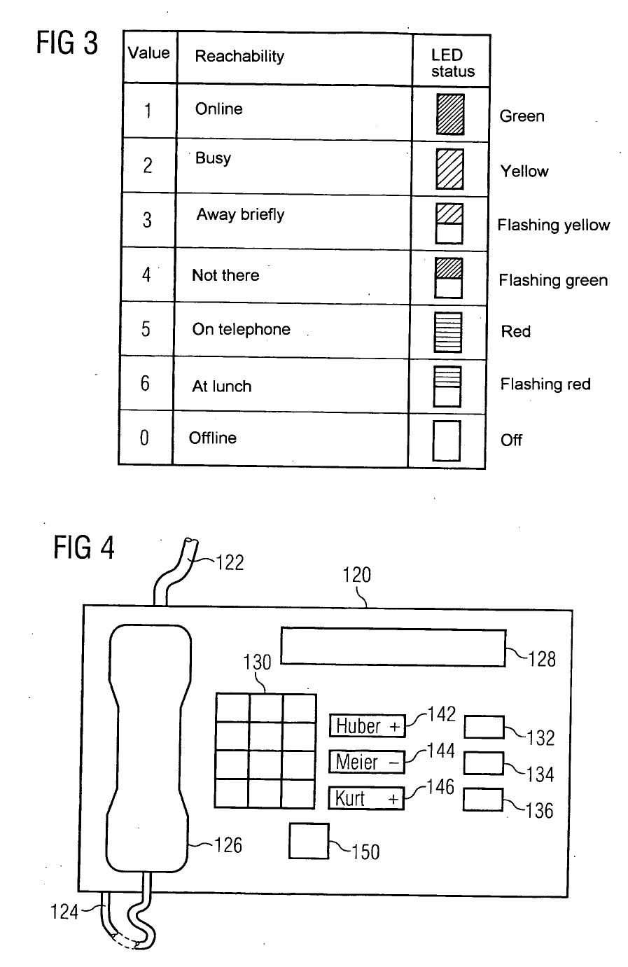

FIG. 3 shows the operational states of an indicating element, in particular a multicolor LED, as a function of the value of an item of reachability data. The different values of the reachability data can, for example, be set using a single key by pressing it several times, or by means of several keys or by computer-assisted input. For example if:
the value “1” for the reachability data specifies that the subscriber concerned is logged onto the operating system of a computer which stands beside his/her terminal device, then for example an LED which shows this reachability data will be so activated that it gives a continuous green light;
the value “2” for the reachability data specifies that the subscriber is busy; the LED shows, for example, a yellow light;
the value “3” specifies that the subscriber is briefly unreachable; the LED shows, for example, a flashing yellow light;
the value “4” specifies that the subscriber is not there, for example because he/she has not yet logged into a time recording system; the LED shows a flashing green light;
the value . “5” specifies that the subscriber is currently on the telephone; the LED shows a continuous red light;
the value “6” specifies that the subscriber is not there because it is a (lunch) break; the LED shows, for example, a flashing red light; and
the value “0” specifies that the subscriber is logged off from an operating system or is working offline, as applicable; the LED is off.

If, instead of the multicolor LEDs mentioned above, monochrome LEDs are used in an alternative form of embodiment, the reachability might, for example, be represented as follows:
Present: the monochrome LED is off,
Present but currently on a call or briefly absent: the monochrome LED flashes,
Absent: the monochrome LED is on.

With other forms of embodiment, further or other reachability states are taken into account. In another form of embodiment, instead of an LED use is made of an LCD element, on which the reachability state can be indicated using letters or symbols.

FIG. 4 shows a telephone 120, which is networked into a telecommunication installation via a connecting line 122 or via a radio transmission link. The telephone 120 has a connection for a telephone handset line 124, which leads to a telephone handset 126. In the telephone handset 126 are a microphone and an earpiece, i.e. a small loudspeaker.

The telephone 120 also has a central display 128 on which is displayed, for example, the directory number of the calling subscriber or the current time. Furthermore, the telephone 120 contains a keypad 130 with, for example, twelve keys, i.e. keys for the digits “0” to “9” and if applicable for one or two control keys, for example a “star” or a “hash” key.

On the right-hand edge of the telephone 120 is a row of three or more quick-dial keys 132, 134 and 136. On the left, beside the quick-dial key 132, there is an LCD display 142, on which is shown the name of the subscriber whose terminal device can be reached via the quick-dial key 132, in the exemplary embodiment the name is “Huber”. The LCD display 132 also shows, by a “+”, that the subscriber “Huber” is ready to take calls.

On the left, beside the quick-dial key 134 there is an LCD display 144, on which is shown the name “Maier”, i.e. the name of the subscriber whose terminal device can be reached via the quick-dial key 134. A “” indicates that the subscriber “Maier” does not wish to be disturbed at present.

On the left, beside the quick-dial key 136 there is an LCD display 146, on which is noted the name of a third subscriber, namely the subscriber “Kurt”. The subscriber “Kurt” can be reached via the quick-dial key 136. A “+” on the LCD display 146 indicates that the subscriber “Kurt” is reachable.

In addition, the telephone 120 contains a key 150 or several keys, which are not used for call-processing purposes, but with the help of which the subscriber who uses the terminal device 120 can specify his/her reachability status. In the key 150 there is, for example, an indicating element which is set according to the reachability state which has been set, see for example FIG. 3. If the subscriber who uses the terminal device 120 presses the key 150 once, for example, then it switches from the state “off” to the state “ready to accept calls”, which is indicated, for example by the LED in the key 150 being illuminated. A change in the reachability state is signaled, using the method explained above by reference to FIG. 1 or 2, as appropriate, to the other terminal devices which wish to be informed of the reachability state for the subscriber on the terminal device 120. A plus sign “+” is then set on each of these terminal devices for the subscriber who uses the terminal device 120, beside his/her quick-dial key.

It is advantageous if this functionality of the key 150 is assigned to a quick-dial key 136. It is then not necessary to make any technical modifications in order to equip the telephone 120 with the facilities of the invention.

In summary it can be said that the reachability status can be determined from a host of data or by a manual input. A mapping function is used to convert the value of an item of reachability data into a display indication or an indication by an LED. Determination of the reachability state and its conversion into a display indication can be effected:
within a switching system by a separate process,
on an external service provision computer by an interface, for example with the help of a CSTA interface,
in other ways.

The mapping function maps the reachability state for each quick-dial key onto one of the following display elements:
an LED with the following operational states, which can be used in combination:
   colors: red, yellow, green (in the case of a multicolor LED)
   brightness: off, medium brightness, bright,
   continuously on or flashing, if necessary at different frequencies,
or with the help of a so-called self-labeling display, i.e. a mini display or segmented display assigned to each name key or direct-dial key. With this, apart from the name of the subscriber other symbolic displays, for example “icons” can be produced. If these displays are monochrome, the possibilities cited for monochrome LEDs can be used, for example different brightnesses or flashing states.

For all the solutions presented it is the case that they provide information, about the presence or reachability of all important call partners, which is visually immediately apparent. If one makes the assumption that the subscribers who can be reached via the quick-dial keys are of particular importance, then a continuously visible presence status is of especial benefit, in particular if this status gives very reliable information. It means that it is not necessary to attempt a call in order to read off the reachability from the central display 128, or to deduce it on the basis of other signals. Attempts to establish calls which are in vain and which load the network unnecessarily are then avoided.

In conjunction with the central display 120 and the menu technique used, for example, by the terminal devices from Siemens AG of the Optiset type or Optipoint type, it is also possible to select additional information, for example alternative call destinations such as cellular communication terminal devices, voice mail etc. These items of information are, for example, visible on the central display at the press of a key.

Technical realization is as simple as it could be:
For example, using multicolor LEDs, which would require no changes to the housing, compared to the housings which have been in use until now. For user-friendly variants, however, a change would be required to the circuit board, together with an enhancement of the activation protocol, to enable the extended functionality to be activated and to ensure ease of use. If monochrome LEDs are used, no further technical modifications are required to the telephone 120 if it was previously already equipped with this type of LED. This LED variant also functions, in particular, even for older devices or for simple devices with no display.
Realization by means of so-called self-labeling displays permits very simple activation to show the presence status, by adding predefined symbols to the character set.

1-16. (cancelled)

17. A method for activating an indicating element, comprising:
operating a reference terminal device in a data transmission network or in a telecommunication network;
equipping the reference terminal device with at least one key, via which an electronic or mechanical switching element assigned to the key is activated and via which a connection to a reachable terminal device is established;
equipping the reference terminal device with at least one indicating element, of which all or a partial area is assigned to the key and the indication on which is dependent on inputs from a user who also uses the reachable terminal device; and
activating the indicating element or the partial area of the indicating element by a reachability data, wherein
the reachability data is a function of inputs by the user of the reachable device, input into a piece of equipment other than the reachable device, or wherein
the reachability data has been entered at the reachable device without a simultaneous setup or release of a connection in the data transmission network or the telecommunication network.

18. The method in accordance with claim 17, wherein a telephone is used as the reference terminal device or as the reachable device and is connected to a telecommunication installation, or is equivalent in the shape of its housing and in the arrangement of the operating elements to a terminal device connected to a telecommunication installation but works instead in a data transmission network.

19. The method in accordance with claim 17, wherein the switching element comprises at least one metallic contact or wherein the switching element is a transistor.

20. The method in accordance with claim 18, wherein the switching element comprises at least one metallic contact or wherein the switching element is a transistor.

21. The method in accordance with claim 17, wherein the other piece of equipment is a piece of equipment used by the user of the reachable terminal device, other than the reachable terminal device, which has access to a data transmission network.

22. The method in accordance with claim 17, wherein the piece of equipment other than the reachable device is a personal computer, a time recording system or a portable computer.

23. The method in accordance with claim 17, wherein
in a central place at least one list is stored, in which are noted the terminal devices to which any change in the reachability data should be signaled, and wherein
changes of the reachability data are signaled to terminal devices as a function of the state of the list.

24. The method in accordance with claim 23, wherein the noting of the reachability data and/or the creation of the list is carried out in accordance with the CSTA standard or in accordance with the SIP standard or in accordance with the H.323 standard or in accordance with a standard based on these standards.

25. The method in accordance with claim 23, wherein a central service provision computer stores the list and notes the reachability data.

26. The method in accordance with claim 17, further comprising:
storing a list in the reachable terminal device, in which are noted the terminal devices to which any change in the reachability data should be signaled; and
sending signaling messages to the terminal devices noted, as a function of the state of the list, for the updating the reachability data.

27. The method in accordance with claim 26, wherein for creating the list and/or signaling a change in the reachability data, use is made of messages conforming to the CSTA standard or conforming to the SIP or conforming to the H.323 standard or conforming to a standard based on these standards.

28. The method in accordance with claim 17, wherein at least one of the following reachability states is noted in the reachability data:
user logged into an operating system or user program or into a data transmission network,
user logged off from an operating system or user program or a data transmission network,
user occupied,
user will be back soon,
user not there,
user is taking a work break, in particular lunch break,
user on the telephone.

29. The method in accordance with claim 17, wherein the method is performed by a program running on a processor.

30. A terminal device, comprising:
at least one indicating element comprising at least one quick-dial key;
a telephone handset or a connection for a telephone handset; and
a housing, wherein
the terminal device can be operated on a telecommunication installation, or wherein the terminal device has a housing shaped like a terminal device which can be operated on a telecommunication installation, wherein
the terminal device comprises at least one reachability key, which can be used to input reachability data without at the same time establishing or releasing a connection.

31. The terminal device in accordance with claim 30, wherein
the key is a key which is used solely for inputting the reachability data into the terminal device, wherein
the key is pressed simultaneously with other keys in order to input reachability data, or wherein the key or keys is/are used to operate a menu, via which reachability data is input.

32. The terminal device in accordance with claim 30, wherein several indicating elements are provided, each of which is arranged beside a key, via which other terminal devices can be reached.

33. The terminal device in accordance with claim 32, wherein each of the indicating elements is an LCD indicator or each is at least one LED.

34. The terminal device in accordance with claim 33, wherein the LEDs have different colors or one LED which can be activated to give different colors.

35. The terminal device in accordance with claim 29, wherein the indicating element comprises display segments, each of which is arranged to be beside a key via which other terminal devices can be reached.
